(19) United States
(12) Patent Application Publication
(10) Pub. No.: US 2015/0126208 A1
(43) Pub. Date: May 7, 2015

(54) Communication Mechanism for Advertising Services

(71) Applicants: Ling Yu, Oulu (FI); Vinh Van Phan, Oulu (FI); Kari Veikko Horneman, Oulu (FI)

(72) Inventors: Ling Yu, Oulu (FI); Vinh Van Phan, Oulu (FI); Kari Veikko Horneman, Oulu (FI)

(21) Appl. No.: 14/398,157

(22) PCT Filed: May 9, 2012
(86) PCT No.: PCT/EP2012/058550

§ 371 Date: Oct. 31, 2014

(51) Int. Cl. H04W 72/12; H04W 72/04

(52) U.S. Cl. CPC H04W 72/1294; H04W 72/042; H04W 72/0453; H04W 72/1273
USPC 455/452.1

(57) ABSTRACT

There is provided a mechanism for controlling a communication using a proximity services or D2D system for advertising services controlled by a cellular network. Configuration information for configuring at least one advertising channel including one or more advertising control channels and one or more advertising traffic channels are provided from a communication control network element to advertising system elements such as an advertising agent device. Scheduling information and advertising information are transmitted from the advertising agent device via downlink control channels and advertising channels, wherein corresponding information are received and processed by an advertising receiving device.

### BACKGROUND OF THE INVENTION

### Field of the Invention

The present invention relates to a mechanism for controlling a communication using a proximity services or D2D system for advertising services. Specifically, the present invention is related to apparatuses, methods and computer program products which provide a communication mechanism usable for advertising services in a proximity services based communication system controlled by a cellular network.

The following meanings for the abbreviations used in this specification apply:

AAD: advertising agent device

ADCCH: advertising control channel

ADTCH: advertising traffic channel

ARD: advertising receiving device

ASD: advertising source device

BS: base station

CN: core network

D2D: device-to-device

DL: downlink

eNB: enhanced node B

ID: identification/identity

LTE: Long Term Evolution

LTE-A: LTE Advanced

MCS: modulation and coding scheme

PDCCH: physical downlink control channel

PRB: physical resource block

ProSe: proximity services

P-ADCCH: primary ADCCH

P-ADTCH: primary ADTCH

RNTI: radio network temporary identity

RRC: radio resource control

S-ADCCH: secondary ADCCH

S-ADTCH: secondary ADTCH

SIB: system information block

UE: user equipment

UL: uplink

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) and fourth generation (4G) communication networks like the Universal Mobile Telecommunications System (UMTS), enhanced communication networks based e.g. on LTE or LTE-A, cellular 2nd generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards for telecommunication network and access environments.

Generally, for properly establishing and handling a communication connection between communication elements such as a user equipment (UE) and another communication element or user equipment, a database, a server, etc., one or more intermediate network elements such as communication network control elements, support nodes or service nodes are involved.

So-called proximity based services, which are also referred to as D2D (or machine-to-machine (M2M)) communications are expected to become one of the key features in future communications networks. ProSe are designed to provide an option to offload (cellular) communications system, reduce battery consumption and increase bit-rate, and hence also enable new services. D2D communications may be implemented as an underlay to an LTE-Advanced network. The network may establish a new type of radio bearer dedicated for D2D communications and stay in control of session setup and radio resources without routing user plane traffic. D2D is considered to be used mainly in shot range applications, such as providing local services.

In network-controlled D2D communications, user devices may have both cellular (at least some default signaling bearers for network control purposes) and D2D bearers configured, thus they may have a “mixed” configuration. The user devices may be configured to switch between communicating with a serving communication network control element, such as an eNB, in a regular cellular access mode (on a cellular radio bearer) and with each other in a D2D mode (on a D2D radio bearer) in a time-division or time-sharing fashion. Thus, D2D communication may be carried out while the user devices are in a discontinuous reception (DRX) mode of the serving cell. A discontinuous reception mode is provided to improve the battery life of a user device and is thus quite typically used in the LTE (-A) networks to provide a better user experience.

In the “mixed” configuration case described above, a network may utilize clusters in order to reduce signaling: an eNB may allocate resources for a cluster and the cluster head or a master device further allocates them to cluster members. It should be understood that acting as a cluster head may require node-like operation from a user device or server. Clusters may also be flexible and thus alter according to needs and/or time. User devices may enter and leave a cluster when they move from one coverage area to another, for example.

Network-controlled D2D communications are in particular suitable for conveying commercial information, such as advertisements or information on products or services ordered by a customer. Some potential Proximity Services (ProSe) are related to e.g. local advertising.

In an exemplifying practical case, for providing D2D based local hyper-advertising services of ProSe-type, a serving (LTE-A) network typically needs to support hundreds of local advertising sources (devices of local restaurants, shops, play stations, e-service machines, etc.) desired to be discovered by thousands of potential receiving ends (devices of customers walking or hanging around) and possibilities for the receiving ends to choose what advertisements they receive and when, and to interact or communicate with selected sources of interest.

### SUMMARY OF THE INVENTION

It is an object of the invention to provide an improved mechanism for controlling a communication using a proximity services or D2D system for advertising services.

These objects are achieved by the measures defined in the attached claims.

According to an example of an embodiment of the proposed solution, there is provided, for example, an apparatus comprising at least one processor, at least one interface to at least one other network element, and at least one memory for storing instructions to be executed by the processor, wherein the at least one memory and the instructions are configured to, with the at least one processor, cause the apparatus at least to perform: a configuration information providing function configured to provide configuration information for configuring at least one advertising channel comprising one or more advertising control channels and one or more advertising traffic channels used in advertising services in a proximity services communication system, wherein the configuration information comprises: an identification element identifying at least one proximity services advertising agent device of the advertising services in the proximity services communication system, and advertising channel scheduling information indicating resources used for transmitting the at least one advertising channel by the identified at least one proximity services advertising agent device.

Furthermore, according to an example of an embodiment of the proposed solution, there is provided, for example, a method comprising providing configuration information for configuring at least one advertising channel comprising one or more advertising control channels and one or more advertising traffic channels used in advertising services in a proximity services communication system, wherein the configuration information comprises: an identification element identifying at least one proximity services advertising agent device of the advertising services in the proximity services communication system, and advertising channel scheduling information indicating resources used for transmitting the at least one advertising channel by the identified at least one proximity services advertising agent device.

According to further refinements, these examples may comprise one or more of the following features:
the configuration information may be provided to receiving network elements comprising at least one of a proximity services advertising agent device, a proximity services advertising source device, and a proximity services advertising receiving device, and the configuration information may be provided to the receiving network elements partly or completely in at least one of the following ways: an indication of hardcoded information, a provision of preconfiguration data provided during an access procedure of the receiving network element to a cellular communication network, and a broadcasting transmission of system information in the cellular communication network;
the identification element may comprise at least one of a physical identification or a logical identification of the at least one proximity services advertising agent device;
the advertising channel scheduling information may comprise at least one of a radio network temporary identifier used for the at least one advertising channel, scheduling information of the at least one advertising channel in time domain, information about a modulation and coding scheme of the at least one advertising channel, and scheduling information of the at least one advertising channel in frequency domain;
an individual set of advertising channel scheduling information allocated to each proximity services advertising agent device may be provided, or a common set of advertising channel scheduling information allocated to plural proximity services advertising agent devices may be provided;
to the proximity services advertising agent device, with the configuration information, further information about allocated downlink control channel resources for delivering information of a primary advertising control channel, scheduling information in frequency domain for the primary advertising control channel, and information about a semi-persistent resource allocation of secondary advertising control channels and secondary advertising traffic channels may be provided;
to the proximity services advertising agent device, with the configuration information, further information about allocated downlink control channel resources for delivering information of a primary advertising control channel, scheduling information in frequency domain for the primary advertising control channel, information about a semi-persistent resource allocation of secondary advertising control channels and secondary advertising traffic channels, and information about allocated downlink control channel resources for secondary advertising control channels and secondary advertising traffic channels may be provided;
with the configuration information, further information about a mapping between a physical identification element of the at least one proximity services advertising agent device and a predefined downlink control channel providing information about the at least one advertising channel, or information about a mapping between a physical identification element of the at least one proximity services advertising agent device and a predefined advertising channel may be provided;
the above aspects may be implemented in a communication network control element, in particular an evolved Node B of a Long Term Evolution or Long Term Evolution Advanced communication network.

According to another example of an embodiment of the proposed solution, there is provided, for example, an apparatus comprising at least one processor, at least one interface to at least one other network element, and at least one memory for storing instructions to be executed by the processor, wherein the at least one memory and the instructions are configured to, with the at least one processor, cause the apparatus at least to perform: a proximity services advertising agent function used in advertising services in a proximity services communication system for delivering advertising information via at least one advertising channel comprising one or more advertising control channels and one or more advertising traffic channels, and a configuration information receiving and processing function configured to receive and process configuration information for configuring the at least one advertising channel, wherein the configuration information comprises: an identification element identifying the proximity services advertising agent function, and advertising channel scheduling information allocated to the identified proximity services advertising agent and indicating resources used for transmitting the at least one advertising channel.

Furthermore, according to another example of an embodiment of the proposed solution, there is provided, for example, a method comprising executing a proximity services advertising agent function used in advertising services in a proximity services communication system for delivering advertising information via at least one advertising channel comprising one or more advertising control channels and one or more advertising traffic channels, and receiving and processing configuration information for configuring the at least one advertising channel, wherein the configuration information comprises: an identification element identifying the proximity services advertising agent function, and advertising channel scheduling information allocated to the identified proximity services advertising agent and indicating resources used for transmitting the at least one advertising channel.

According to further refinements, these examples may comprise one or more of the following features:
the configuration information may be received partly or completely from a cellular communication network control element, and the configuration information may be received partly or completely in at least one of the following ways: an indication of hardcoded information, a provision of preconfiguration data provided during an access procedure of the apparatus to a cellular communication network, and a broadcasting transmission of system information in the cellular communication network;
the identification element may comprise at least one of a physical identification or a logical identification of an apparatus comprising the proximity services advertising agent function;
advertising channel scheduling information may comprise at least one of a radio network temporary identifier used for the at least one advertising channel, scheduling information of the at least one advertising channel in time domain, information about a modulation and coding scheme of the at least one advertising channel, and scheduling information of the at least one advertising channel in frequency domain.
an individual set of advertising channel scheduling information allocated to the proximity services advertising agent function may be received and processed, or a common set of advertising channel scheduling information allocated to plural proximity services advertising agent functions may be received and processed;
on the basis of the configuration information, advertising channel scheduling information may be transmitted via at least one of a downlink control channel being synchronized with a downlink control channel transmitted from a cellular communication network control element and an advertising control channel;
from the received configuration information, information about allocated downlink control channel resources for delivering information of a primary advertising control channel, scheduling information in frequency domain for the primary advertising control channel, and information about a semi-persistent resource allocation of secondary advertising control channels and secondary advertising traffic channels may be derived, and the scheduling information in frequency domain for the primary advertising control channel may be transmitted on the allocated downlink control channel resources;
from the received configuration information, information about allocated downlink control channel resources for delivering information of a primary advertising control channel, scheduling information in frequency domain for the primary advertising control channel, information about a semi-persistent resource allocation of secondary advertising control channels and secondary advertising traffic channels, and information about allocated downlink control channel resources for delivering information about secondary advertising control channels and secondary advertising traffic channels may be derived, and the scheduling information for the primary and secondary advertising control channels may be transmitted on the respective allocated downlink control channel resources;
advertising information of different advertising source devices to be transmitted in the advertising services in the proximity services communication system may be arranged into plural categories, to each category respective advertising channels for delivering control and scheduling information may be assigned, and mapping information indicating a mapping between each category and the assigned advertising channels may be provided;
advertising information of different advertising source devices to be transmitted in the advertising services in the proximity services communication system may be arranged into plural categories, to each category respective advertising channels for delivering control and scheduling information may be assigned, and scheduling information related to the assigned advertising channels may be transmitted in an advertising control channel, wherein the scheduling information may be identified by a category related identifier;
a category based change notification for indicating a change in information transmitted via the advertising channels allocated to a respective category may be provided;
a predefined downlink control channel may be used, or a predefined advertising channel may be used for providing information about the at least one advertising channel, wherein the predefined downlink control channel or the predefined advertising channel may be mapped on a physical identification element related to the proximity services advertising agent function;
the above aspects may be implemented in a communication element, in particular an terminal or server device usable and configured as a proximity services advertising agent device communicating with and controlled by a communication network control element such as an evolved Node B of a Long Term Evolution or Long Term Evolution Advanced communication network.

According to still another example of an embodiment of the proposed solution, there is provided, for example, an apparatus at least one processor, at least one interface to at least one other network element, and at least one memory for storing instructions to be executed by the processor, wherein the at least one memory and the instructions are configured to, with the at least one processor, cause the apparatus at least to perform: a proximity services advertising receiving function used in advertising services in a proximity services communication system for receiving advertising information delivered via at least one advertising channel comprising one or more advertising control channels and one or more advertising traffic channels, and a configuration information receiving and processing function configured to receive and process configuration information for configuring the at least one advertising channel, wherein the configuration information comprises: an identification element identifying at least one proximity services advertising agent device of the advertising services in the proximity services communication system, and advertising channel scheduling information indicating resources used for transmitting the at least one advertising channel by the identified at least one proximity services advertising agent device.

Moreover, according to still another example of an embodiment of the proposed solution, there is provided, for example, a method comprising executing a proximity services advertising receiving function used in advertising services in a proximity services communication system for receiving advertising information delivered via at least one advertising channel comprising one or more advertising control channels and one or more advertising traffic channels, and receiving and processing configuration information for configuring the at least one advertising channel, wherein the configuration information comprises: an identification element identifying at least one proximity services advertising agent device of the advertising services in the proximity services communication system, and advertising channel scheduling information indicating resources used for transmitting the at least one advertising channel by the identified at least one proximity services advertising agent device.

According to further refinements, these examples may comprise one or more of the following features:
the configuration information may be received partly or completely from a cellular communication network control element, and the configuration information may be received partly or completely in at least one of the following ways an indication of hardcoded information, a provision of preconfiguration data provided during an access procedure of the apparatus to a cellular communication network, and a broadcasting transmission of system information in the cellular communication network;
the identification element may comprise at least one of a physical identification or a logical identification of the at least one proximity services advertising agent device;
the advertising channel scheduling information may comprise at least one of a radio network temporary identifier used for the at least one advertising channel, scheduling information of the at least one advertising channel in time domain, information about a modulation and coding scheme of the at least one advertising channel, and scheduling information of the at least one advertising channel in frequency domain;
an individual set of advertising channel scheduling information allocated to the proximity services advertising agent function may be received and processed, or a common set of advertising channel scheduling information allocated to plural proximity services advertising agent functions may be received and processed;
on the basis of the configuration information, advertising channel scheduling information may be received via at least one of a downlink control channel being synchronized with a downlink control channel transmitted from a cellular communication network control element and an advertising control channel transmitted from a proximity services advertising agent device;
from the received configuration information, information about downlink control channel resources may be derived in which information regarding a primary advertising control channel may be transmitted, and scheduling information in frequency domain for the primary advertising control channel may be received via the derived downlink control channel resources, and further information regarding the advertising channels may be received via the primary advertising control channel on the basis of the received scheduling information;
from the received configuration information, information about downlink control channel resources may be derived in which information regarding primary and secondary advertising control channels is transmitted, and scheduling information for the primary and secondary advertising control channels may be received via the derived downlink control channel resources, and further information regarding the advertising channels may be received via the primary and secondary advertising control channel on the basis of the received scheduling information;
mapping information indicating a mapping between categories, in which advertising information of different advertising source devices to be transmitted in the advertising services in the proximity services communication system are arranged, and advertising channels respectively assigned to each category for delivering control and scheduling information may be received, and information only from advertising channels assigned to a selected category may be received and processed;
the advertising channels to be received and processed may be selected on the basis of an identifier linked to the category;
a category based change notification for indicating a change in information transmitted via the advertising channels allocated to a respective category may be received and processed;
mapping information indicating a mapping of a physical identification element of a proximity services advertising agent device and a predefined downlink control channel providing information about the at least one advertising channel, or mapping information indicating a mapping of a physical identification element of a proximity services advertising agent device and a predefined advertising channel may be received and processed, and information for advertising services via the predefined downlink control channel or the predefined advertising channel may be received;
the above aspects may be implemented in a communication element, in particular a terminal or server device usable and configured as a proximity services advertising receiving device communicating with and controlled by a communication network control element such as an evolved Node B of a Long Term Evolution or Long Term Evolution Advanced communication network.

In addition, according to examples of the proposed solution, there is provided, for example, a computer program product for a computer, comprising software code portions for performing the steps of the above defined methods, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

By virtue of the proposed solutions, it is possible to provide a communication mechanism by means of which advertising services in a proximity services based communication system controlled by a cellular network can be provided and used in a proper way. Specifically, by means of the proposed communication mechanism, local advertising sources (also referred to as ASDs) can provide information to potential receivers (also referred to as ARDs) in a suitable way by using a server or agent function (also referred to AADs) while means for choosing what advertisements are received and for obtaining information for communicating with selected sources of interest are provided. Moreover, the transmission of information via advertising channel from AADs can be configured in a suitable manner while ASD and ARD elements are provided with information assisting in a discovery of AAD transmissions.

The above and still further objects, features and advantages of the invention will become more apparent upon referring to the description and the accompanying drawings.

### BRIEF DESCRIPTION OF THE DRAWINGS

FIG. 1 shows a diagram illustrating a communication network configuration where examples of embodiments of the invention are implemented.

FIG. 2 shows a diagram illustrating examples of system information blocks used for providing configuration information transmitted by a cellular network according to examples of embodiments of the invention are implemented.

FIG. 3 shows a diagram illustrating an advertising channel structure according to examples of embodiments of the invention.

FIG. 4 shows a diagram illustrating an alternative advertising channel structure according to examples of embodiments of the invention.

FIG. 5 shows a flowchart illustrating a processing executed in a communication network control element according to examples of embodiments of the invention.

FIG. 6 shows a flowchart illustrating a processing executed in a communication element functioning as an AAD according to examples of embodiments of the invention.

FIG. 7 shows a flowchart illustrating a processing executed in a communication element functioning as an ARD according to examples of embodiments of the invention.

FIG. 8 shows a block circuit diagram of a communication network control element including processing portions conducting functions according to examples of embodiments of the invention.

FIG. 9 shows a block circuit diagram of a communication element functioning as an AAD and including processing portions conducting functions according to examples of embodiments of the invention.

FIG. 10 shows a block circuit diagram of a communication element functioning as an ARD and including processing portions conducting functions according to examples of embodiments of the invention.

### DESCRIPTION OF PREFERRED EMBODIMENTS

In the following, examples and embodiments of the present invention are described with reference to the drawings. For illustrating the present invention, the examples and embodiments will be described in connection with a cellular communication network based on a 3GPP LTE or LTE-A system with network elements being capable of conducting a D2D communication for proximity services. However, it is to be noted that the present invention is not limited to an application using such types of communication system, but is also applicable in other types of communication systems and the like.

A basic system architecture of a communication network where examples of embodiments of the invention are applicable may comprise a commonly known architecture of one or more communication systems comprising a wired or wireless access network subsystem and a core network. Such an architecture may comprise one or more communication network control elements like access network control elements, radio access network elements, access service network gateways or base transceiver stations, such as a base station (BS) or eNB, which control a coverage area also referred to as a cell and with which one or more communication elements or terminal devices such as a UE or another device having a similar function, such as a modem chipset, a chip, a module etc., which can also be part of a UE or attached as a separate element to a UE, or the like, are capable to communicate via one or more channels for transmitting several types of data. Furthermore, a core network comprising elements such as gateway network elements, policy and charging control network elements, mobility management entities and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a communication element like a UE or a communication network control element like an eNB, besides those described in detail herein below.

Furthermore, the described network elements, such as communication elements like ARDs, ASD and AADs (which may be terminal devices like UEs or dedicated network elements or servers) or communication network control elements like BSs or eNBs and the like, as well as corresponding functions as described herein may be implemented by software, e.g. by a computer program product for a computer, and/or by hardware. In any case, for executing their respective functions, correspondingly used devices, nodes or network elements may comprise several means and components (not shown) which are required for control, processing and communication/signaling functionality. Such means may comprise, for example, one or more processor units including one or more processing portions for executing instructions, programs and for processing data, memory means for storing instructions, programs and data, for serving as a work area of the processor or processing portion and the like (e.g. ROM, RAM, EEPROM, and the like), input means for inputting data and instructions by software (e.g. floppy disc, CD-ROM, EEPROM, and the like), user interface means for providing monitor and manipulation possibilities to a user (e.g. a screen, a keyboard and the like), interface means for establishing links and/or connections under the control of the processor unit or portion (e.g. wired and wireless interface means, an antenna, etc.) and the like. It is to be noted that in the present specification processing portions should not be only considered to represent physical portions of one or more processors, but may also be considered as a logical division of the referred processing tasks performed by one or more processors.

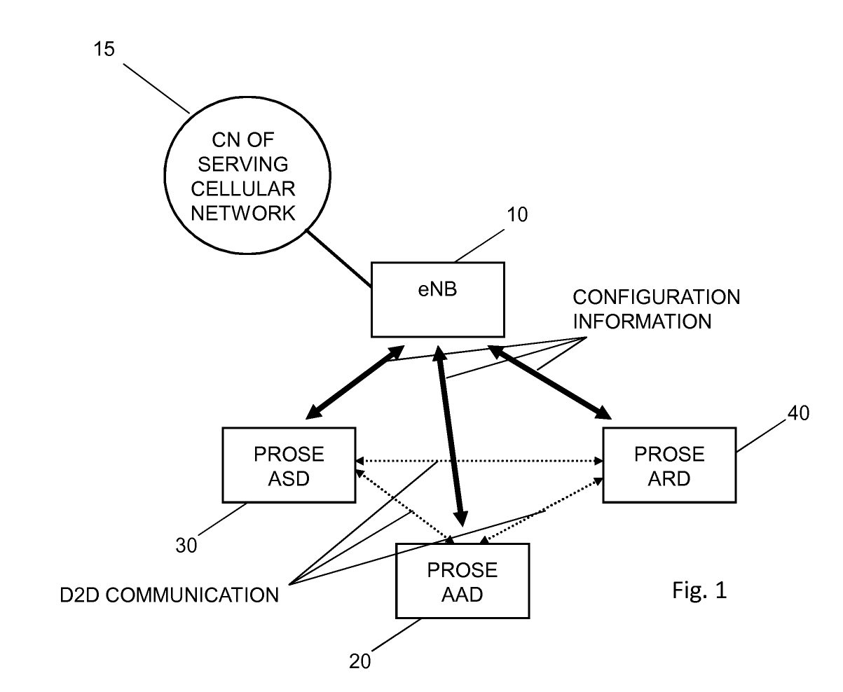

With regard to FIG. 1, a diagram illustrating a general configuration of a communication network where examples of embodiments of the invention are implemented. It is to be noted that the configuration shown in FIG. 1 shows only those devices network elements and parts which are useful for understanding principles underlying the examples of embodiments of the invention. As also known by those skilled in the art there may be several other network elements or devices involved in a connection between the communication elements and the network which are omitted here for the sake of simplicity.

In FIG. 1, a communication network configuration is illustrated in which examples of embodiments of the invention are implementable. The network according to FIG. 1 is for example based on 3GPP LTE or LTE-A specifications. It is to be noted that the general functions of the elements described in connection with FIG. 1 as well as of reference points/interfaces therebetween are known to those skilled in the art so that a detailed description thereof is omitted here for the sake of simplicity.

As shown in FIG. 1, in the exemplary communication network, reference sign 10 denotes a communication network control element of a cellular communication network, such as an eNB of a LTE(A) based communication network. Reference sign 15 denotes a core network part of the cellular communication network to which the eNB 10 belongs.

Reference sign 20 denotes a communication element, such as a terminal device or server element, which functions as a ProSe AAD element (referred to hereinafter also as AAD). It is to be noted that there may be more than one AAD 20.

Reference sign 30 denotes a communication element, such as a terminal device or server element, which functions as a ProSe ASD element (referred to hereinafter also as ASD). It is to be noted that there may be more than one ASD 30.

Reference sign 40 denotes a communication element, such as a terminal device, which functions as a ProSe ARD element (referred to hereinafter also as ARD). It is to be noted that there may be more than one ARD 40.

It is to be noted that the names of devices, units, modules etc., such as ProSe AAD, ProSe ARD, are not limiting but chosen to be descriptive and separable enough to be used in explaining their roles and/or functionality.

The elements indicated in FIG. 1 are configured to communicate with each other. Specifically, as shown by bold arrows in FIG. 1, the communication network control element such as the eNB 10 communicates with the ProSe AAD 20, the ProSe ASD 30 and the ProSe ARD 20 via a cellular communication path, for example for providing configuration information. On the other hand, the ProSe AAD 20, the ProSe ASD 30 and the ProSe ARD 20 communicate with each other via D2D communication paths, for example (indicated by dashed arrows in FIG. 1).

In the following, examples are described explaining the configuration of the system shown in FIG. 1 and the function of the elements thereof.

In order to provide a system capable of advertising and delivering commercial information, ProSe AAD 20 is used to serve typically a group of local ProSe ASD(s) 30 which wish to deliver commercial information locally. The ProSe AAD 20 cooperates with a ProSe ASD to transmit or broadcast an advertisement over a certain service area, wherein the transmission is at least in part configured and controlled by the cellular network (i.e. eNB 10).

The ProSe ASD 30 may be configured to deliver advertisements by a request of an end user or customer, or automatically, for instance in a certain area for a certain period of time.

The ProSe ARD 40 is introduced to provide an end-user an option to listen to or receive advertisements by their own initiative. The ProSe ARD 40 may receive an advertisement when located in a certain service area wherein this deliver operation may be allowed and/or assisted by the network.

It is to be noted that advertising may mean all kinds of commercial information, such as advertisements of products or services, additional information of a product or service of interest requested by a possible customer, contact information, information on business hours, preview material (such as videoclips of films), recommendations of products or services, banners, etc.

The ProSe AAD 20 may be selected among local ProSe ASDs dynamically. ProSe ASDs may be associated and thus enabled to communicate with selected ProSe AAD(s). For example, a communication network control element, such as the eNB 10, configures an apparatus capable to D2D communications to operate as a ProSe AAD (for example a ProSe ASD device). Alternatively, a ProSe ASD is associated with an existing AAD. The local D2D device may be dynamically selected or semi-statically deployed and reconfigured to operate as a ProSe AAD for one or more local ProSe ASD which may be located within the D2D range of the (configured) ProSe AAD. The local D2D device may be a “general-purpose” mobile device or a specific device or machine configured and controlled by a serving network. On the other hand, a device wishing to deliver commercial information may be chosen to operate as a ProSe AAD for its own needs and even for other ProSe ASD. It may be a “general-purpose” mobile device or a specific device or machine configured and controlled by a serving network as well. For instance, a ProSe AAD may be selected among local co-located ProSe ASDs and reconfigured dynamically on-the-fly in a self-organizing networks (SON) based fashion or deployed semi-statically in a pre-configuring fashion by the serving network. The next generation mobile networks (NGMN) alliance and 3rd generation partnership project (3GPP) have standardized a set of capabilities known as self-organizing networks (SON). SON is targeted to simplify operation and maintenance of networks and thus decrease operational expenses (OPEX) by reducing pre-planning of network configurations. SON provides self-configuring of networks for “plug-and-play” devices and also some self-operating and self-optimization features, such as multivendor tracing, quality-of-services optimization and interference control.

The ProSe AAD 20 may be kept in a RRC connected state with regard to a serving (cellular) network for control and management purposes. Hence, the ProSe AAD 20 may be configured to convey common control signaling concerning advertising-agent identity, capability and capacity including imposed access limitations and restrictions over designated radio channel(s). The ProSe AAD may also be configured to interact with the serving network for updates or changes in statuses, conditions, users including associated ProSe ASDs, etc.

The communication network control element, such as the eNB 10, may determine whether to select and configure a ProSe ASD to operate as a ProSe AAD or to associate it with one or more existing co-located ProSe AADs based on measurement reports and service requests from the ProSe ASD in question. Thus, a ProSe ASD may, upon an initial access or an updated request for a ProSe service or in response to a request from the serving network, report about detected suitable ProSe AADs. The report may include information on their identities, profile characteristics, capabilities, locations, etc.

The ProSe ASD 30 may also indicate its own profile and capability information, advertising need, location information, and/or status information including available power and network connectivity options or conditions (such as whether ProSe ASD has sufficient power supply or an alternative network connection via other than cellular access, such as fixed line with a valid Internet Protocol (IP) address).

It should be appreciated that a serving network may also provide assistance for a ProSe ASD in the detection of suitable ProSe AADs, such as mapping location information and service request of the ProSe ASD to perform updated location awareness information stored in the serving network.

The serving network may choose as a suitable ProSe AAD a ProSe ASD that is in an isolated position and has not detected suitable ProSe AADs or has only a few ProSe AADs around which are in less advantageous directions for radio communications or has not sufficient capability. Some other criteria may be at least one of the following: available capacity, power supply, and a possible alternative network connection (such as IP) of ProSe ASDs in question, and special advertising needs or targeted users, etc.

When the serving network is associating a ProSe ASD to a selected ProSe AAD, the serving network configures and controls both the ProSe ASD(s) and the selected ProSe AAD for possible D2D communications between these devices. In this case, the ProSe AAD may operate as a master device (or a cluster head when a group of ProSe ASDs are involved) for the ProSe ASD(s). When D2D communications is successfully established between the ProSe ASD(s) and the ProSe AAD, the serving network may command the ProSe ASD(s) 30 in a sleep mode (DRX) in a radio resource control connected state or in an idle state in the serving network's point of view, while maintaining a D2D connection with the ProSe AAD 20 for needed services. The ProSe AAD may operate as an “access point” for ProSe agent services of interest for ProSe ASD(s). If the D2D communication fails, the serving network may provide mediating services between the ProSe ASD and the ProSe AAD.

The serving network (eNB 10) may command ProSe AAD 20 to carry out a transmission power ramp-up or -down upon each addition, modification or removal of an associated ProSe ASD or a requested ProSe service, using derivation rules, up/down power adjustment steps and/or maximum/minimum allowed power levels, etc.

It should be appreciated that a (cellular) network may receive a service request from a ProSe ASD which may include information on priority and/or commercial information factor identifying the piece of information in question. The network may convey the information to selected ProSe AAD (AAD 20).

The ProSe AAD 20 is provided with commercial information for local delivery. Commercial information is typically made previously and stored in a memory unit controlled by a server or the like. The memory unit may be controlled by the network server or by a separate service provider's server. An example of such a service provider is a web advertising company or a radio/TV broadcasting company. The service provider may also be a local company, such as a restaurant, which wishes to provide its' commercial information independently or by using an appropriate advertising or corresponding service. Home nodes may be used for this purpose as well. Cloud services may also be utilized.

The network server may transmit the commercial information in question to the ProSe AAD 20 serving a desired geographical area, such as a town, part of a town or city, shopping center, or particular street etc.

Then, the ProSe AAD 20 can deliver the commercial information to at least one receiving device (i.e. ProSe ARD 40) wherein it is also possible to send the information to at least one second local ProSe AAD (not shown). The delivery may be carried out by transmitting or broadcasting the commercial information via a wireless connection to receiving devices in the area served by the ProSe AAD 20. The receiving devices are typically devices of customers listening to radio, watching TV or browsing network. The customers may also be passive, that is they have their devices open but they are not actively using them at the moment of the information delivery.

Regarding the operation of the ProSe ASDs, the following is also to be considered. If no suitable ProSe AAD is detected, information to operate as a local proximity services advertising agent device may be obtained from a serving network (eNB 10).

A ProSe ASD may detect available ProSe AADs periodically and obtained results are stored for later use or the detection is carried out in relation to need to convey commercial information. In the detection, the device may listen to ProSe AADs to find out which ones it can hear and it may even transmit some kind of an access message. If at least one suitable ProSe AAD is detected, the serving network (e.g. eNB 10) is informed about the suitable ProSe AAD, wherein information for being associated to the suitable ProSe AAD is then received.

The ProSe ASD as a source device may communicate with the server storing commercial information or it may store it itself. If the commercial information is stored outside the source device, it may request the commercial information from the server controlling the storage. The delivery of the commercial information may be launched by a request from a receiving device, such as a request for additional information on a service or product of interest, or it may be launched by the source device, such as broadcasting an advertisement in a selected area in selected time.

The ProSe ARD 40 may obtain commercial information from the ProSe ASD 30 via the ProSe AAD 20 by a dedicated transmission or by broadcasting transmission from the ProSe AAD 20. For example, the ProSe ARD 40 may initiate a local D2D call or other suitable typically radio connection to the ProSe ASD 30 via the local ProSe AAD 20 from which the ProSe ARD 40 receives the commercial information. A commercial information forwarding indicator, such as a flooding factor or flag, may relate to obtained commercial information of the ProSe ASD in question (or to one or more possible intermediate ProSe AADs (not shown)). Otherwise a connection request to a (cellular) network may be initiated indicating that the connection is in relation to the obtained commercial information. Thus an end user or client may indicate his or her interest to obtain more detailed or related information. The connection may provide a connection to a web page providing the more detailed information or more detailed commercial information may be transmitted, etc.

In a further example, the communication system may have more than one ProSe AAD used for delivering the advertising information. The example is presented herein only for clarification purposes and it should not be taken as limiting implementation. For example, a system may comprise two ProSe AADs wherein one. ProSe AAD operates as a “first tier” device which may further communicate with another “second tier” ProSe AAD. The “first tier” ProSe AADs is an “original” ProSe AAD and the “second tier” ProSe AAD is an intermediate ProSe AADs as will be further clarified in the following:

For example, a ProSe ASD may request commercial information having a specified priority and one or more commercial information factors, also called flooding factors which determine desirable scheduling allocation and extending range of the commercial information. For instance, a flooding factor may be used to request whether (a particular piece of) ProSe commercial information should be kept in a selected geographical area that is to say, kept within the D2D range of the requesting ProSe ASD, and thus broadcasted by a direct neighboring ProSe AAD(s) (also referred to as 1st tier), or forwarded to and broadcasted by one or more intermediate ProSe AAD which are located outside the D2D range of the requesting ProSe ASD (also referred to 2nd and farther tier(s)). In this regard, a ProSe AAD upon conveying commercial information (or advertising) of a ProSe ASD to a next ProSe AAD or end users may also indicate one or more commercial information factors (flooding factors or flags) e.g. by using indicating flags, associated with the commercial information. In one more specific example, the flag is set to 1 when the direct or original ProSe AAD receives a service request directly from the original ProSe ASD and then incrementally increased by 1 each time a ProSe AAD passes it further to the next one over a possible D2D connection (until the maximum value is reached).

The serving network (e.g. the eNB) may provide assistance in conveying requested commercial information to selected ProSe AADs over the service area of interest and/or configure the flooding factor or flag to selected ProSe AADs, especially when a D2D connection between ProSe AADs is not in use, out of order, or established.

A ProSe ARD, upon initiating a call request to reach a ProSe ASD, may indicate to a serving network (the eNB) the flooding factor or flag corresponding to the received information. Based on that, the serving network may determine whether to establish regular cellular access connections to the ProSe ARD and the ProSe ASD to conduct communications, or to use D2D communications. Additionally, a ProSe ARD may, upon receiving commercial information from a direct ProSe AAD (tier 1) and wishing to contact the original ProSe ASD for further information or transaction, try initiating communications directly with the ProSe AAD it is currently listening to over an existing D2D connection. The ProSe AAD in question is also configured to support direct communications of this type.

In other words, according to the above described examples, it is possible to provide scalable and secure local hyper-advertising services using e.g. LTE-A network controlled D2D communications, as shown in FIG. 1, wherein ProSe AADs are provided to serve a group of local ProSe ASDs which have need to advertise locally, for enhancing scalability and efficiency of ProSe local hyper advertising services. A ProSe AAD can be selected dynamically among local ProSe ASDs, and a ProSe ASD can be associated to and communicate with a selected ProSe AAD. Power boosting for e.g. relevant control and traffic channel(s) of a ProSe AAD can be transmitted depending on the number of associated ProSe ASDs, characteristics and service requests thereof. Furthermore, a configurable flooding factor of ProSe advertising information can be introduced which may be requested by a ProSe ASD to extend the reachable range or service area toward listeners for a particular item of ProSe advertising information in need.

In the following, examples of embodiments of the invention are described which are related to a communication mechanism usable in the above described communication system as shown in FIG. 1, in particular to arrangements of advertising channels and interactions between the ProSe advertising system elements, such as ProSe AAD and ProSe ARD, with the serving cellular network, i.e. a corresponding communication network control element such as the eNB. It is to be noted that the communication system used for examples of embodiments of the invention is configured in such a manner that the ProSe AAD is fully controlled by the serving cellular network over the air interface.

According to examples of embodiments of the invention, a flexible channel structure for hyper-advertising services in proximity services communication is provided in which advertising channels are used for delivering at least a part of control or scheduling information for receiving advertising information by using one or more Advertising Control Channels (ADCCH) and for delivering the advertising information (e.g. from ProSe ASDs associated to a ProSe ADD) by using one or more Advertising Traffic Channels (ADTCH).

According to examples of embodiments of the invention, in order to configure the communication system so as to provide control information and traffic data via advertising channels, a communication network control element of the serving cellular network, such as the eNB 10, provide configuration information usable by the ProSe advertising elements, such as ProSe AAD 20, ProSe ASD 30 and ProSe ARD 40 for exchanging data. Specifically, according to examples of embodiments of the invention, the eNB 10 provides static/semi-static configuration information for a transmission of data by the ProSe AAD 20 via advertising channel which allows the ProSe AAD to suitably configure the transmission of control information and traffic data, and assists the ProSe ASD 30 and the ProSe ARD 40 in a discovery procedure for ProSe AAD transmission.

According to examples of embodiments of the invention, the respective ProSe advertising element, such as ProSe AAD 20, ProSe ASD 30 and ProSe ARD 40 are provided with the advertising channel configuration information in different ways. For example, at least a part of the advertising channel configuration information is hardcoded in the respective device. Alternatively or additionally, at least a part of the advertising channel configuration information is pre-configured when the corresponding ProSe element, i.e. the ProSe AAD 20, the ProSe ASD 30 and the ProSe ARD 40 accesses to the cellular network (i.e. to the eNB 10), that is corresponding information are transmitted during the access phase of the device, or when the ProSe advertising system is configured, as described in connection with FIG. 1. Alternatively or additionally, at least a part of the advertising channel configuration information is broadcasted by the serving cellular network (e.g. the eNB 10), for example in combination with broadcasted system information (such as SIB signaling).

According to examples of embodiments of the invention, the configuration information includes at least the following items.

A first part of the configuration information indicates an identifier for the ProSe AAD, referred to as ProSe AAD ID. For example, the ProSe AAD ID is a physical ID (corresponding to certain reference/synchronization sequence); alternatively or additionally, the ProSe AAD ID includes a logical ID. It is to be noted that in case the ProSe hyper-advertising service is a localized service, i.e. has a limited coverage area, it is possible to re-use the same ProSe AADs ID for multiple ProSe AADs, for example it is ensured that they do not interfere with each other (i.e. two ProSe AADs having the same ID can be received at the same time).

A second part of the configuration information comprises control data or scheduling information regarding a transmission of advertising channels by the ProSe AAD, i.e. ProSe AAD advertising channel scheduling information. For example, the scheduling information includes one or more of the following elements:
According to examples of embodiments of the invention, a temporary identifier, such as an RNTI, used for ProSe AAD advertising channel is indicated. The temporary identifier is used when a synchronized downlink control channel such as a synchronized PDCCH is used for delivering additional resource allocation information for the advertising channels. This is helpful, for example, for receiving elements such as ProSe ARDs to get initial advertising channel scheduling information by using a standard receiving mechanism, e.g. for PDCCH transmission.
Furthermore, according to examples of embodiments of the invention, the scheduling information part of the configuration information comprises static/semi-static scheduling information of advertising channels in time domain, such as an interval between transmissions of control channels, a radio frame and/or subframe offset, the repetition factor, a modification period etc. By means of this information, it is possible, for example, to inform a ProSe ARD about when to listen to ProSe AAD advertising channels.
Moreover, according to examples of embodiments of the invention, the scheduling information includes a modulation and coding scheme (MCS) of the advertising channels.
In addition, according to examples of embodiments of the invention, the scheduling information part includes scheduling information in frequency domain, for example in case it is possible to configure the same in static/semi-static way.

According to examples of embodiments of the invention, the scheduling information is common to plural or even all ProSe AAD IDs in the communication system. That is, plural or all ProSe AADs send the advertising channels by using the same resources. Alternatively, according to further examples of embodiments of the invention, each ProSe AAD (i.e. different ProSe AAD ID groups) has a dedicated advertising channel configuration, i.e. specific advertising channel scheduling information.

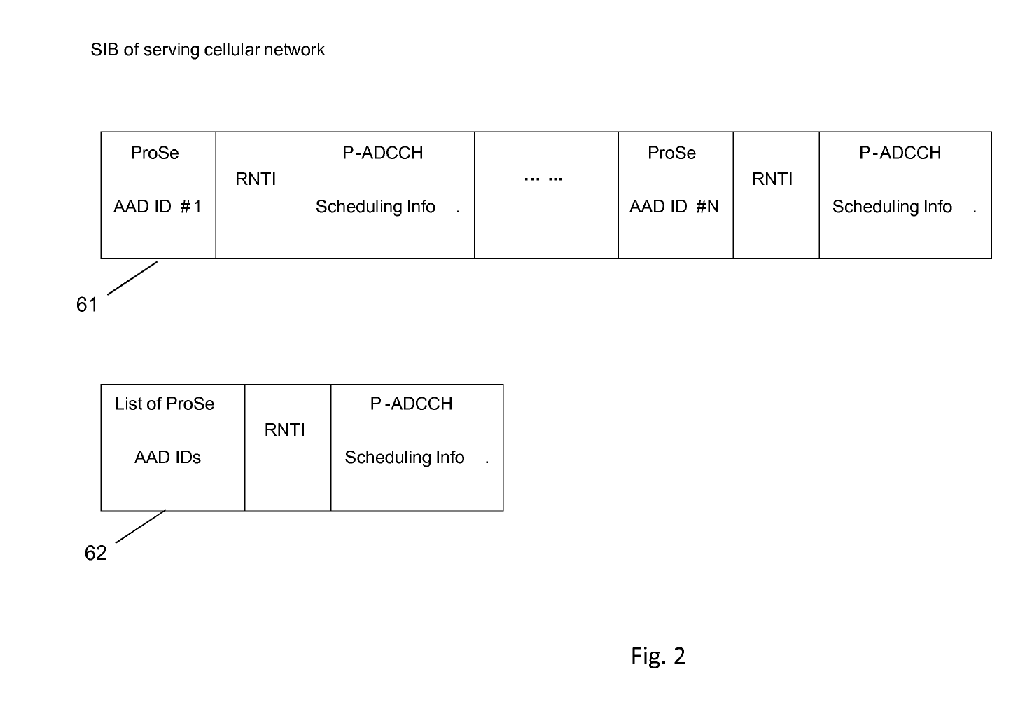

FIG. 2 shows examples of a possible way for providing configuration information by means of a broadcasting transmission of corresponding SIB from the eNB 10.

Specifically, reference sign 61 denotes a structure of a SIB when each ProSe AAD ID is provided with an own set of scheduling information. That is, the SIB comprises for each ProSe AAD ID a corresponding field, followed by a field comprising an indication of the corresponding temporary identifier, and a field indicating scheduling information for the advertising channel(s) (in FIG. 2, the scheduling information of the primary control channel P-ADCCH is indicated as an example). Thus sub-structure of fields is repeated for each ProSe AAD ID (#1 to #N).

On the other hand, reference sign 62 denotes a structure of a SIB when a common set of scheduling information is used for plural or all ProSe AADs. Then, the SIB comprises a field indicating a list of the ProSe AAD IDs using the scheduling information, followed by a field comprising an indication of the corresponding temporary identifier (which may be also common to all ProSe AAD in this case), and a field indicating the common scheduling information for the advertising channel(s).

As described above, according to examples of embodiments of the invention, the ProSe AAD 20 is synchronized with the serving cellular network and configured to have the coordinated and synchronized PDCCH transmission with the serving cellular network for providing scheduling information of advertising channels. Hence, a receiving device, such as the ProSe ARD 40 can use the normal PDCCH monitoring mechanism to get the resource allocation for ProSe AAD advertising channels.

In order to achieve this, according to examples of embodiments of the invention, the ProSe AAD 20, upon being configured by the serving cellular network (e.g. by the eNB 10) in the way as described above, stays in RRC connected state and keeps its advertising transmission synchronized with the downlink transmission of the serving cellular network, for example with the PDCCH transmission of the eNB 10.

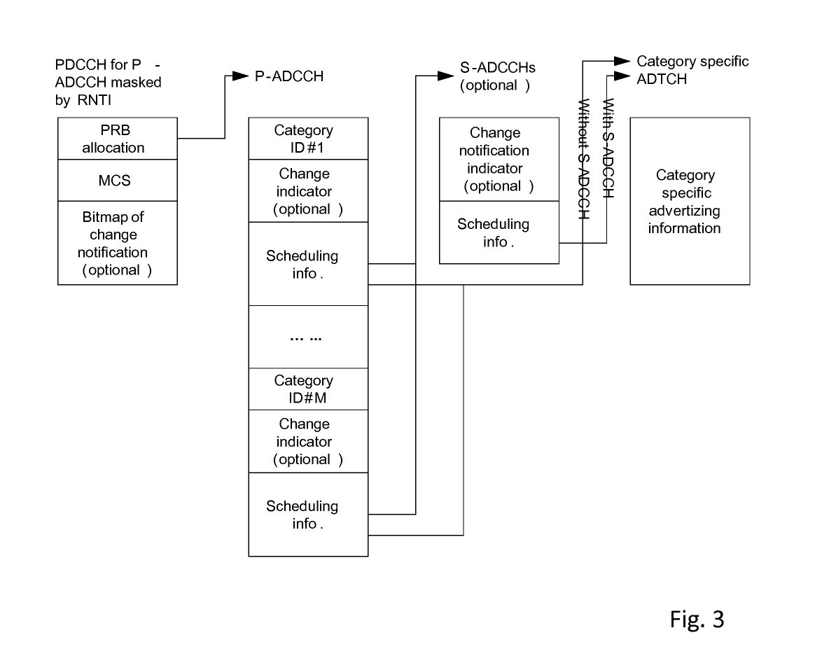

FIG. 3 shows an example according to embodiments of the invention of a channel structure of advertising channels (ADCCH and ADTCH) under the assumption of an LTE-A based serving cellular network. Specifically, FIG. 3 shows one alternative of a configuration of advertising channels and the provision of scheduling information thereabout by the ProSe AAD 20 based on configuration information provided by the eNB 10.

Specifically, according to the example shown in FIG. 3, only the frequency domain scheduling information of the primary ADCCH is delivered on the synchronized PDCCH that is transmitted by the ProSe AAD 20. This is shown in the leftmost column indicating the content of the PDCCH for providing information of the P-ADCCH masked by the RNTI. The information provided on the PDCCH comprises the PRB allocation (resources) for the P-ADCCH transmission, the MCS used by the advertising channel, and (optionally) a notification of changes (to be described later).

In the second column, the information provided by the P-ADCCH is indicated. In the example shown in FIG. 3, the ProSe ASDs are categorized for example according to the type of advertisement, the type of source (restaurant, shop etc.), and the like. Correspondingly, for the respective categories, an ID (#1 to #M) is used, wherein for each category ID a corresponding scheduling information indication and a (optional) change indicator are provided. That is, according to examples of embodiments of the invention, scheduling information transmitted in primary (and optional a secondary ADCCH) is arranged on a category basis and identified by the category IDs or a category based ADTCH ID, for example.

According to further examples of embodiments of the invention, it is possible to use, in addition to the primary advertising channel (and a corresponding ADTCH) also one or more secondary advertising channels. In this case, scheduling information of secondary ADCCHs is provided by primary ADCCH (e.g. in the scheduling information part thereof). Such a secondary advertising channel is indicated in the third column in FIG. 3, which comprises also a (optional) change indicator and scheduling information.

As also indicated in FIG. 3 by arrows leading to the fourth (rightmost) column in FIG. 3, scheduling information for of the (primary or secondary) ADTCH is provided by primary or secondary ADCCHs (in FIG. 3 both case of a configuration with and without secondary advertising channels is depicted). The ADTCH delivers the (category specific) advertising information (traffic data), i.e. the actual advertisement.

In an advertising channel configuration as shown in FIG. 3, the serving cellular network (eNB 10) configures the ProSe AAD 20 for the advertising information transmission by providing, in the configuration information or by another suitable mechanism, information regarding the PDCCH resources to be used for delivering the resource allocation information (PRB allocation) of the (primary) ADCCH, the (primary) ADCCH scheduling information in frequency domain, and a semi-persistent resource allocation of secondary ADCCHs (if used) and (primary or secondary) ADTCHs. By means of this information, the ProSe AAD 20 can transmit the (primary) ADCCH frequency domain scheduling information on the configured PDCCH resources by using the RNTI which is broadcasted in the related system information of the serving cellular network.

With regard to the category based structure of the ADCCHs and ADTCHs shown in FIG. 3, this is used by ProSe AAD 20 to provide a multiplexed transmission of advertising information of different ProSe ASDs. For example, the ProSe AAD 20 is configured with multiple ADTCHs and optional multiple secondary ADCCHs for delivering control and multiplexed advertising information of the ProSe ASDs (e.g. ProSe ASD 30) associated with the ProSe AAD 20.

According to further examples of embodiments of the invention, the ProSe AAD 20 provides by means of the primary ADCCH, in addition to the scheduling information of the other advertising channels (secondary ADCCH, primary ADTCH et.) mapping information indicating a mapping between the categories and the corresponding secondary ADCCHs and ADTCHs.

With regard to the category based change notification of the advertising information, which is provided in the ADCCH, according to further examples of embodiments of the invention, this notification is introduced to avoid continuous receiving of the same advertising message by a ProSe ARD. For example, the change notification is indicated by a bitmap transmitted on PDCCH for primary ADCCH to allow quick notice of the change in each category. Alternatively or additionally, as shown in FIG. 3, the change notification may be indicated together with other category specific information on (primary or secondary) ADCCHs.

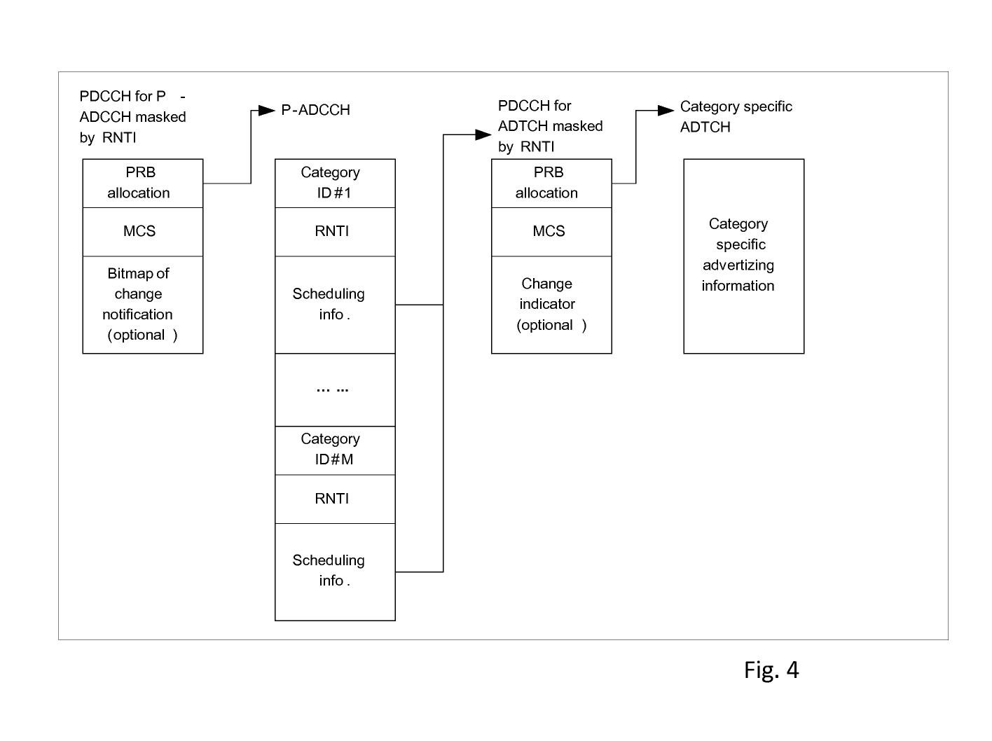

FIG. 4 shows another example according to embodiments of the invention of a channel structure of advertising channels (ADCCH and ADTCH) under the assumption of an LTE-A based serving cellular network. Specifically, FIG. 4 shows another alternative of a configuration of advertising channels and the provision of scheduling information thereabout by the ProSe AAD 20 based on configuration information provided by the eNB 10.

According to the example depicted in FIG. 4, scheduling information of both ADCCHs and ADTCHs is delivered on the synchronized PDCCH that is transmitted by ProSe AAD. This is indicated by the first (leftmost) column and the third column in FIG. 4, indicating the content of the PDCCH for providing information of the ADCCH and the ADTCH masked by the RNTI. The information provided on the PDCCH comprises the PRB allocation (resources) for the ADCCH and ADTCH transmission, the MCS used by the advertising channel, and (optionally) a notification of changes.

In an advertising channel configuration as shown in FIG. 4, the serving cellular network (eNB 10) configures the ProSe AAD 20 for the advertising information transmission by providing, in the configuration information or by another suitable mechanism, information regarding the PDCCH resources to be used for delivering the resource allocation information (PRB allocation) of the ADCCH, information regarding the PDCCH resources to be used for delivering resource allocation information (PRB allocation) of second ADCCHs and ADTCHs, the ADCCH scheduling information in frequency domain, and a semi-persistent resource allocation of secondary ADCCHs (if used) and (primary or secondary) ADTCHs.

By means of this information, the ProSe AAD 20 can transmit the primary ADCCH for providing necessary scheduling information (e.g. RNTIs used for secondary ADCCHs and ADTCHs, the time occasions to monitor PDCCH for secondary ADCCHs and optional ADTCHs) of (secondary) ADCCHs and ADTCHs so as to enable a receiving element, such as the ProSe ARD 40, to know when and how to access ProSe AAD 20 for receiving the advertising information.

As in the example shown and described in connection with FIG. 3, in the example of FIG. 4, the scheduling information transmitted in primary (and optionally secondary) ADCCHs can be arranged on a category basis and identified by the category IDs or category based ADTCH IDs. In the example according to FIG. 4, the RNTIs used for secondary ADCCHs and ADTCHs can be linked to the advertising categories so that the ProSe ARDs have to monitor the PDCCH only for the RNTIs corresponding the categories that the user of the ProSe ARD is interested in. This simplifies the detection of interesting advertisement and reduces the load of the ARD for discarding unwanted advertisement.

Similarly, as in the example shown and described in connection with FIG. 3, in the example of FIG. 4, the category based change notification of the advertising information can be introduced to avoid continuous receiving of the same advertising message by ProSe ARDs, for example by an indication of a bitmap transmitted on PDCCH, so as to allow quick notice of the change in each category. Furthermore, as indicated in the example according to FIG. 4, each category change notification can be indicated in the PDCCH for the category specific (secondary) ADCCHs and ADTCHs.

In another implementation of a communication mechanism according to examples of embodiments of the invention, an identification, such as the physical ID of the ProSe AAD, is linked to a static PDCCH configuration for advertising channels. That is, a ProSe AAD is linked to a predetermined downlink control channel configuration by means of its ID. Information indicating the mapping between the ID (e.g. the physical ID) used by a ProSe AAD and the PDCCH configuration can be provided by means of configuration information or by another suitable way, and can be hardcoded, pre-configured and/or broadcasted in the system information of the serving cellular network. Thus, according to this example of embodiments of the invention, when a ProSe ARD discovers a signaling from the ProSe AAD, the ProSe ARD can be tuned to the right PDCCH for obtaining the resource allocation of the advertising channels by using the mapping information.

In yet another implementation of a communication mechanism according to examples of embodiments of the invention, only one advertising channel is provided by the ProSe AAD 20 for all the control and traffic (advertising) data transmission. According to this example, the serving cellular network (e.g. the eNB 10) provides, via preconfiguration or broadcasted system information, mapping information for indicating a mapping between the ID of the ProSe ADD (e.g. the physical ID used by ProSe AAD) and the advertising channel configuration of the single advertising channel. Hence, according to this example of embodiments of the invention, when a ProSe ARD discovers a signaling from the ProSe AAD, the ProSe ARD can directly access the advertising channel based on the detected physical ID of the ProSe AAD by using the mapping information.

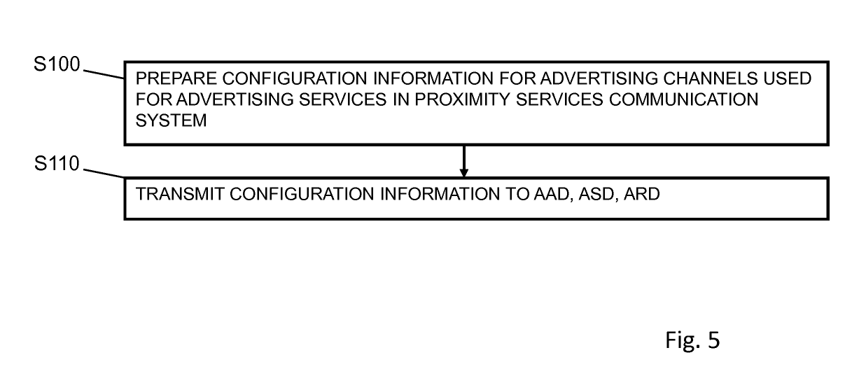

FIG. 5 shows a flowchart illustrating a processing executed in a communication network control element like eNB 10 of FIG. 1 according to examples of embodiments of the invention in a communication mechanism for advertising services.

In step S100, configuration information for one or more advertising channels used for advertising services in a proximity services communication system are prepared. The preparation is done, for example, in a communication network control element, such as eNB 10.

As described above, the configuration information comprises an ID identifying at least one ProSe AAD of the advertising services in the proximity services communication system (e.g. a physical ID and/or logical ID of the ProSe AAD), and advertising channel scheduling information indicating resources used for transmitting the at least one advertising channel by the identified at least one ProSe AAD. The advertising channel scheduling information may comprise at least one of a radio network temporary identifier (RNTI) used for the at least one advertising channel, scheduling information of the at least one advertising channel in time domain, information about a modulation and coding scheme of the at least one advertising channel, and scheduling information of the at least one advertising channel in frequency domain. Furthermore, resources to be used on a downlink control channel, such as PDCCH, are provided. It is possible to provide an individual set of advertising channel scheduling information allocated to each ProSe AAD ID, or a common set of advertising channel scheduling information allocated to plural (or all) ProSe AADs.

It is also possible to provide, together with the configuration information, information about a mapping between a physical ID of the ProSe AAD and a predefined PDCCH providing information about the advertising channel. Alternatively, it is possible to provide information about a mapping between a physical ID of the ProSe AAD and a predefined advertising channel configuration.

In step S110, the configuration information is provided (or transmitted) to receiving network elements of the advertising communication system, for example to ProSe AAD 20, ProSe ASD 30 and ProSe ARD 40. For providing the configuration information to the receiving network elements, different way can be used for a part or complete provision of the configuration information, such as an indication of hardcoded information, a provision of preconfiguration data provided during an access procedure of the receiving network element to a cellular communication network, and a broadcasting transmission of system information in the cellular communication network.

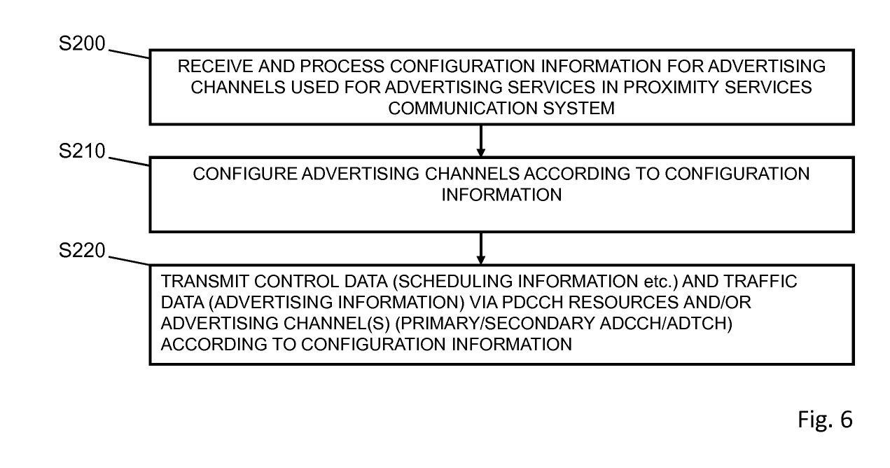

FIG. 6 shows a flowchart illustrating a processing executed in a communication element like a ProSe AAD 20 of FIG. 1 according to examples of embodiments of the invention in a communication mechanism for advertising services.

In step S200, configuration information for one or more advertising channels used for advertising services in a proximity services communication system are received and processed. The processing is done, for example, in a communication element used as a ProSe AAD 20.

As described above, the configuration information comprises an ID identifying the ProSe AAD (e.g. a physical ID and/or logical ID of the ProSe AAD), and advertising channel scheduling information indicating resources used for transmitting the at least one advertising channel by the identified ProSe AAD 20. The advertising channel scheduling information may comprise at least one of a radio network temporary identifier (RNTI) used for the at least one advertising channel, scheduling information of the at least one advertising channel in time domain, information about a modulation and coding scheme of the at least one advertising channel, and scheduling information of the at least one advertising channel in frequency domain. Furthermore, resources to be used on a downlink control channel, such as PDCCH, are provided. It is possible to provide an individual set of advertising channel scheduling information allocated to the ID of the ProSe AAD 20, or a common set of advertising channel scheduling information allocated to plural (or all) ProSe AADs.

It is also possible to provide, together with the configuration information, information about a mapping between a physical ID of the ProSe AAD and a predefined PDCCH providing information about the advertising channel. Alternatively, it is possible to provide information about a mapping between a physical ID of the ProSe AAD and a predefined advertising channel configuration.

The configuration information may be received partly or completely from a cellular communication network control element such as eNB 10. Furthermore, the configuration information may be received partly or completely in at least one of the following ways: an indication of hardcoded information, a provision of preconfiguration data provided during an access procedure of the ProSe AAD to a cellular communication network, and a broadcasting transmission of system information in the cellular communication network.

In step S210, the advertising channels are configured according to the configuration information. That is, control data such as scheduling information and traffic data such as advertising information are allocated to specified channels of e.g. downlink control channels to be transmitted by the ProSe AAD 20 in synchronization with the cellular communication network (e.g. PDCCH) or advertising channels (ADCCH, ADTCH), as described in connection with FIG. 3 or FIG. 4, for example. That is, for example, a categorization of the advertising information (or ProSe ASDs) is conducted and considered in the arrangement of the advertising channels allocation. Also a category based change notification as described above can be considered.

Moreover, according to examples of embodiments of the invention, in the configuration of the advertising channels, a predefined PDCCH configuration or a predefined advertising channel configuration is considered which is mapped on a physical ID of the ProSe AAD, for example.

In step S220, the control data and the traffic data are sent via the configured paths/channels, e.g. via PDCCH, P-ADCCH, S-ADCCH(s), P-ADTCH, S-ADTCH in order to provide the scheduling information for the advertising channels and the advertising information to receiving elements, such as a ProSe ARD.

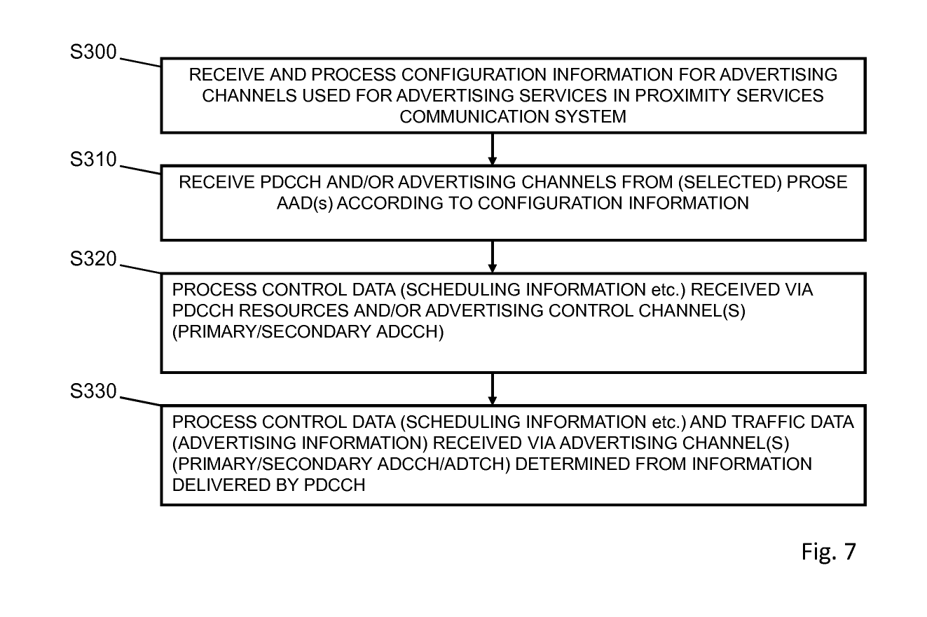

FIG. 7 shows a flowchart illustrating a processing executed in a communication element like a ProSe ARD 40 of FIG. 1 according to examples of embodiments of the invention in a communication mechanism for advertising services.

In step S300, configuration information for one or more advertising channels used for advertising services in a proximity services communication system are received and processed. The processing is done, for example, in a communication element used as a ProSe ARD 40.

As described above, the configuration information comprises an ID identifying at least one ProSe AAD (e.g. a physical ID and/or logical ID of the ProSe AAD), and advertising channel scheduling information indicating resources used for transmitting the at least one advertising channel by the identified ProSe AAD 20. The advertising channel scheduling information may comprise at least one of a radio network temporary identifier (RNTI) used for the at least one advertising channel, scheduling information of the at least one advertising channel in time domain, information about a modulation and coding scheme of the at least one advertising channel, and scheduling information of the at least one advertising channel in frequency domain. Furthermore, resources to be used on a downlink control channel, such as PDCCH, are provided. It is possible to provide an individual set of advertising channel scheduling information allocated to the ID of each ProSe AAD, or a common set of advertising channel scheduling information allocated to plural (or all) ProSe AADs.

It is also possible to provide, together with the configuration information, information about a mapping between a physical ID of a ProSe AAD and a predefined PDCCH providing information about the advertising channel. Alternatively, it is possible to provide information about a mapping between a physical ID of the ProSe AAD and a predefined advertising channel configuration.

The configuration information may be received partly or completely from a cellular communication network control element such as eNB 10. Furthermore, the configuration information may be received partly or completely in at least one of the following ways: an indication of hardcoded information, a provision of preconfiguration data provided during an access procedure of the ProSe AAD to a cellular communication network, and a broadcasting transmission of system information in the cellular communication network.

In step S310, the PDCCH is monitored in order to obtain (initial) scheduling information for advertising channels transmitted by the ProSe AAD. Alternatively, also a predefined advertising channel allocated to a specific ProSe AAD ID may be monitored. For example, the ProSe ARD 40 monitors for PDCCH transmission of ProSe AAD 20 in order to obtain scheduling information for advertising channels such as P-ADCCH sent by the ProSe AAD 20, as described in connection with FIG. 3 or FIG. 4.

The information received in the (initial) control channel monitoring is processed in step S320 so as to derive the transmission resources used for ADCCHs and ADTCHs.

Based on the corresponding scheduling information received from the PDCCH, in step S330, the advertising channel(s) including ADCCHs and ADTCHs are received for determining scheduling information for advertising channels transmitted therein or, if correspondingly decided, advertising information transmitted in ADTCHs are received on the basis of scheduling information received via ADCCH(s).

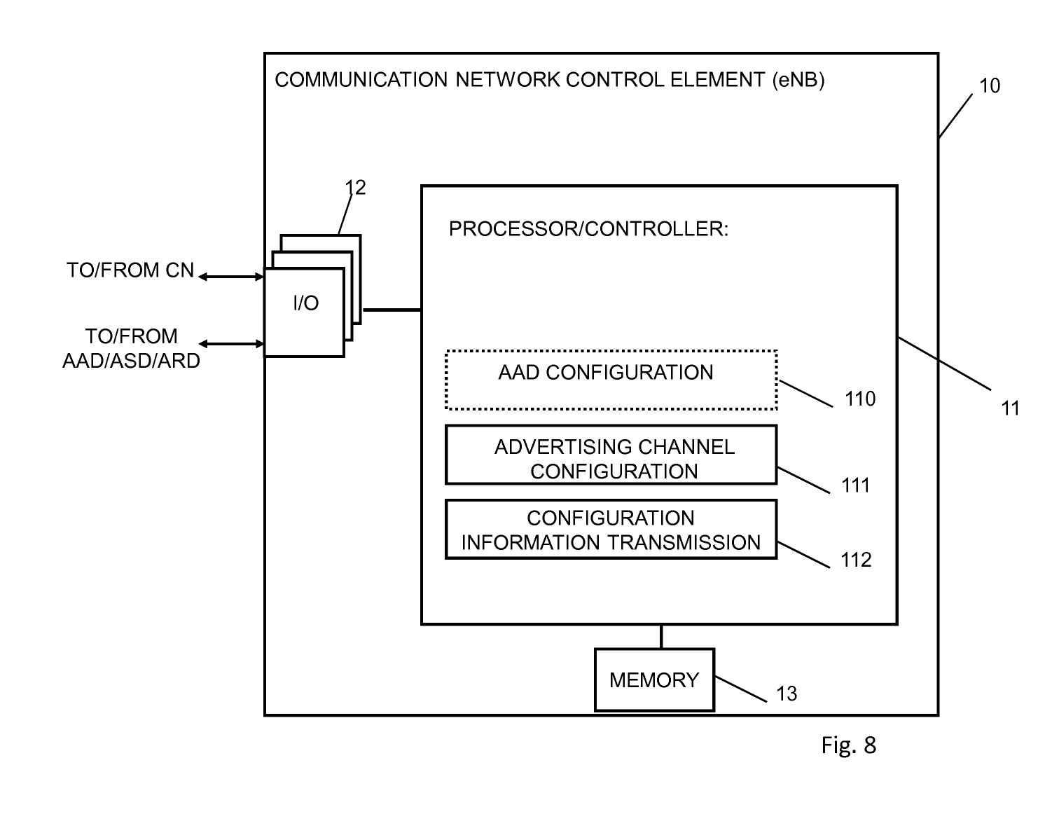

In FIG. 8, a block circuit diagram illustrating a configuration of a communication network control element, such as of eNB 10, is shown, which is configured to implement the communication mechanism usable for advertising services in a proximity services based communication system controlled by a cellular network as described in connection with the examples of embodiments of the invention. It is to be noted that the communication network control element or eNB 10 shown in FIG. 8 may comprise several further elements or functions besides those described herein below, which are omitted herein for the sake of simplicity as they are not essential for understanding the invention. Furthermore, even though reference is made to an eNB, the communication network element may be also another device having a similar function, such as a modem chipset, a chip, a module etc., which can also be part of a control element or BS or attached as a separate element to a BS, or the like.

The communication network control element or eNB 10 may comprise a processing function or processor 11, such as a CPU or the like, which executes instructions given by programs or the like related to the communication mechanism usable for advertising services in a proximity services based communication system controlled by a cellular network. The processor 11 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 12 denotes transceiver or input/output (I/O) units (interfaces) connected to the processor 11. The I/O units 12 may be used for communicating with a core network 15 or communication element like a UEs and servers, in particular the ProSe AAD 20, the ProSe ASD 30 and the ProSe ARD 40 of FIG. 1. The I/O unit 12 may be a combined unit comprising communication equipment towards several network elements, or may comprise a distributed structure with a plurality of different interfaces for different network elements. Reference sign 13 denotes a memory usable, for example, for storing data and programs to be executed by the processor 11 and/or as a working storage of the processor 11.

The processor 11 is configured to execute a processing related to the above described communication mechanism usable for advertising services in a proximity services based communication system controlled by a cellular network. In particular, the processor 11 comprises a sub-portion 110 as a processing portion which is usable for conducting a configuration of a network element, such as a server or a ProSe ASD into a ProSe AAD. The portion 110 may be an optional function. Furthermore, the processor 11 comprises a sub-portion 111 usable as a portion for configuring advertising channels, i.e. for deciding on an allocation of resources for the advertising channel(s) and for delivering information thereabout. The portion 111 may be configured to perform processing according to step S100 of FIG. 5, for example. In addition, the processor 11 comprises a sub-portion 112 as a processing portion which is usable for providing or transmitting the configuration information according to the results of the advertising channel configuration processing. The portion 112 may be configured to perform processing according to step S110 of FIG. 5, for example.

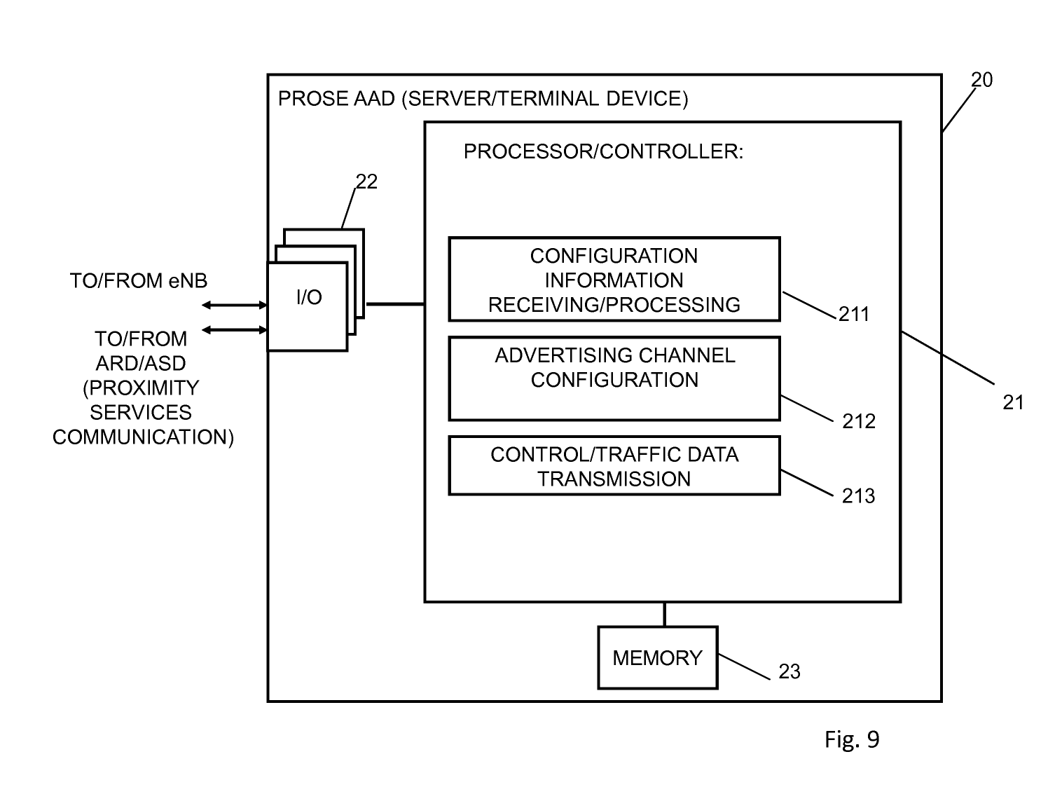

In FIG. 9, a block circuit diagram illustrating a configuration of a communication element, such as of the ProSe AAD 20 illustrated in FIG. 1 is shown, which is configured to implement the communication mechanism usable for advertising services in a proximity services based communication system controlled by a cellular network as described in connection with the examples of embodiments of the invention. It is to be noted that the communication element or ProSe AAD 20 shown in FIG. 9 may comprise several further elements or functions besides those described herein below, which are omitted herein for the sake of simplicity as they are not essential for understanding the invention. Furthermore, even though reference is made to a ProSe AAD, the communication element may be also another device having a similar function, such as terminal device, a server, a modem chipset, a chip, a module etc., which can also be part of a ProSe AAD or attached as a separate element to a ProSe AAD, or the like.

The communication element or ProSe AAD 20 may comprise a processing function or processor 21, such as a CPU or the like, which executes instructions given by programs or the like related to the communication mechanism usable for advertising services in a proximity services based communication system controlled by a cellular network. The processor 21 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 22 denotes transceiver or input/output (I/O) units (interfaces) connected to the processor 21. The I/O units 22 may be used for communicating with a communication network control element of a cellular network, such as eNB 10, and for D2D communication with other elements of the advertising system, such as ProSe ASD 30 and ProSe ARD 40 of FIG. 1. The I/O unit 22 may be a combined unit comprising communication equipment towards several network elements, or may comprise a distributed structure with a plurality of different interfaces for different network elements. Reference sign 23 denotes a memory usable, for example, for storing data and programs to be executed by the processor 21 and/or as a working storage of the processor 21.

The processor 21 is configured to execute a processing related to the above described communication mechanism usable for advertising services in a proximity services based communication system controlled by a cellular network. In particular, the processor 21 comprises a sub-portion 211 as a processing portion which is usable for receiving and processing configuration information for advertising channels. The portion 211 may be configured to perform processing according to step S200 of FIG. 6, for example. Furthermore, the processor 21 comprises a sub-portion 212 usable as a portion for configuring advertising channels, i.e. for using the configuration information for assigning which information (control/traffic data) is to be sent via which resource/channel. The portion 212 may be configured to perform processing according to step S210 of FIG. 6, for example. In addition, the processor 21 comprises a sub-portion 213 as a processing portion which is usable for transmitting the control and traffic data via the configured channels (PDCCH, advertising channels). The portion 213 may be configured to perform processing according to step S230 of FIG. 6, for example.

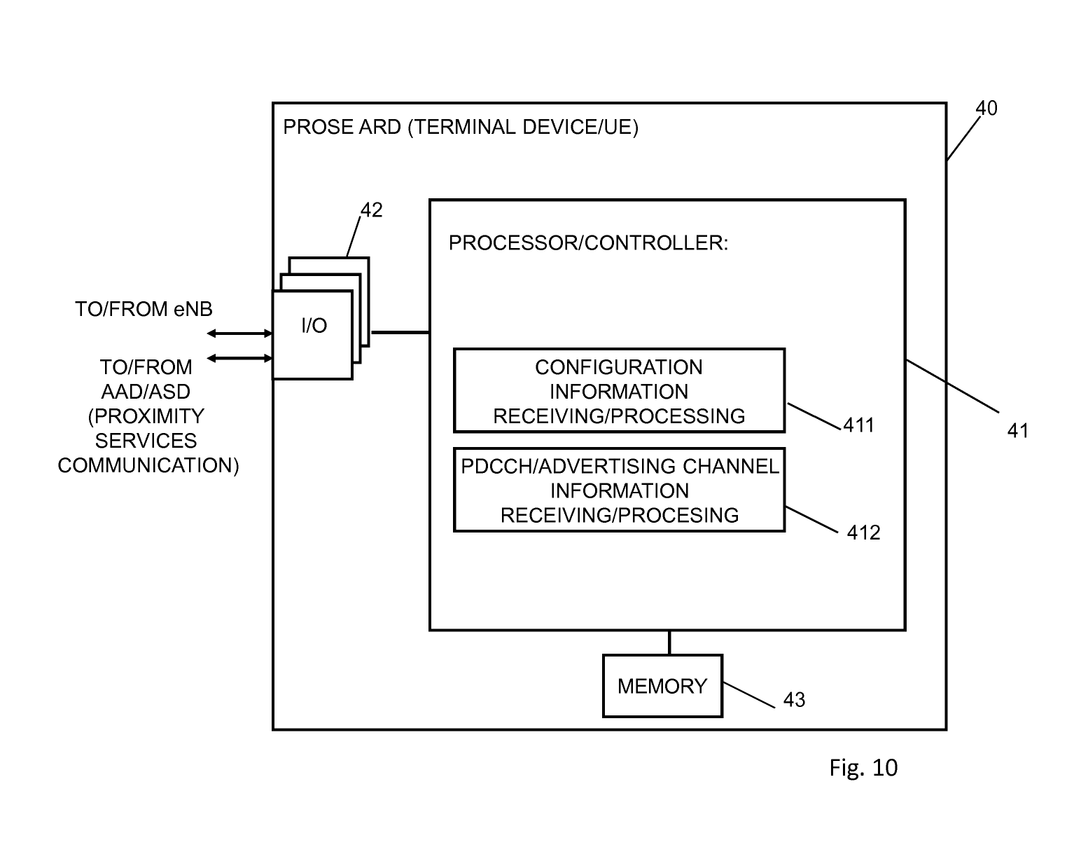

In FIG. 10, a block circuit diagram illustrating a configuration of a communication element, such as of the ProSe ARD 40 illustrated in FIG. 1 is shown, which is configured to implement the communication mechanism usable for advertising services in a proximity services based communication system controlled by a cellular network as described in connection with the examples of embodiments of the invention. It is to be noted that the communication element or ProSe ARD 40 shown in FIG. 10 may comprise several further elements or functions besides those described herein below, which are omitted herein for the sake of simplicity as they are not essential for understanding the invention. Furthermore, even though reference is made to a ProSe ARD, the communication element may be also another device having a similar function, such as terminal device, a server, a modem chipset, a chip, a module etc., which can also be part of a ProSe ARD or attached as a separate element to a ProSe ARD, or the like.

The communication element or ProSe ARD 40 may comprise a processing function or processor 41, such as a CPU or the like, which executes instructions given by programs or the like related to the communication mechanism usable for advertising services in a proximity services based communication system controlled by a cellular network. The processor 41 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 42 denotes transceiver or input/output (I/O) units (interfaces) connected to the processor 41. The I/O units 42 may be used for communicating with a communication network control element of a cellular network, such as eNB 10, and for D2D communication with other elements of the advertising system, such as ProSe ASD 30 and ProSe AAD 20 of FIG. 1. The I/O unit 42 may be a combined unit comprising communication equipment towards several network elements, or may comprise a distributed structure with a plurality of different interfaces for different network elements. Reference sign 43 denotes a memory usable, for example, for storing data and programs to be executed by the processor 41 and/or as a working storage of the processor 41.

The processor 41 is configured to execute a processing related to the above described communication mechanism usable for advertising services in a proximity services based communication system controlled by a cellular network. In particular, the processor 41 comprises a sub-portion 411 as a processing portion which is usable for receiving and processing configuration information for advertising channels. The portion 411 may be configured to perform processing according to step S300 of FIG. 7, for example. Furthermore, the processor 41 comprises a sub-portion 412 usable as a portion for receiving and processing the control and traffic data (scheduling information, advertising information) from the ProSe AAD 20 via corresponding channels (PDCCH, advertising channels) derived from the configuration information or from the received data. The portion 412 may be configured to perform processing according to steps S310 to S330 of FIG. 7, for example.

According to further examples of embodiments of the invention, there is provided an apparatus comprising configuration information providing means for providing configuration information for configuring at least one advertising channel comprising one or more advertising control channels and one or more advertising traffic channels used in advertising services in a proximity services communication system, wherein the configuration information comprises: an identification element identifying at least one proximity services advertising agent device of the advertising services in the proximity services communication system, and advertising channel scheduling information indicating resources used for transmitting the at least one advertising channel by the identified at least one proximity services advertising agent device.

In addition, according to further examples of embodiments of the invention, there is provided an apparatus comprising proximity services advertising agent means used in advertising services in a proximity services communication system for delivering advertising information via at least one advertising channel comprising one or more advertising control channels and one or more advertising traffic channels, and configuration information receiving and processing means for receiving and processing configuration information for configuring the at least one advertising channel, wherein the configuration information comprises: an identification element identifying the proximity services advertising agent function, and advertising channel scheduling information allocated to the identified proximity services advertising agent and indicating resources used for transmitting the at least one advertising channel.

In addition, according to further examples of embodiments of the invention, there is provided an apparatus comprising proximity services advertising receiving means used in advertising services in a proximity services communication system for receiving advertising information delivered via at least one advertising channel comprising one or more advertising control channels and one or more advertising traffic channels, and configuration information receiving and processing means for receiving and processing configuration information for configuring the at least one advertising channel, wherein the configuration information comprises an identification element identifying at least one proximity services advertising agent device of the advertising services in the proximity services communication system, and advertising channel scheduling information indicating resources used for transmitting the at least one advertising channel by the identified at least one proximity services advertising agent device.

For the purpose of the present invention as described herein above, it should be noted that
an access technology via which signaling is transferred to and from a network element may be any technology by means of which a network element or sensor node can access another network element or node (e.g. via a base station or generally an access node). Any present or future technology, such as WLAN (Wireless Local Access Network), WiMAX (Worldwide Interoperability for Microwave Access), LTE, LTE-A, Bluetooth, Infrared, and the like may be used; although the above technologies are mostly wireless access technologies, e.g. in different radio spectra, access technology in the sense of the present invention implies also wired technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable communication networks, stations and transmission nodes may be or comprise any device, apparatus, unit or means by which a station, entity or other user equipment may connect to and/or utilize services offered by the access network; such services include, among others, data and/or (audio-) visual communication, data download etc.;
a user equipment or communication network element (station) may be any device, apparatus, unit or means by which a system user or subscriber may experience services from an access network, such as a mobile phone or smart phone, a personal digital assistant PDA, or computer, or a device having a corresponding functionality, such as a modem chipset, a chip, a module etc., which can also be part of a UE or attached as a separate element to a UE, or the like;
method steps likely to be implemented as software code portions and being run using a processor at a network element or terminal (as examples of devices, apparatuses and/or modules thereof, or as examples of entities including apparatuses and/or modules for it), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved; for example, for executing operations and functions according to examples of embodiments of the invention, one or more processors may be used or shared in the processing, or one or more processing sections or processing portions may be used and shared in the processing, wherein one physical processor or more than one physical processor may be used for implementing one or more processing portions dedicated to specific processing as described,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

As described above, there is provided mechanism for controlling a communication using a proximity services or D2D system for advertising services controlled by a cellular network. Configuration information for configuring at least one advertising channel comprising one or more advertising control channels and one or more advertising traffic channels are provided from a communication control network element to advertising system elements such as an advertising agent device. Scheduling information and advertising information are transmitted from the advertising agent device via downlink control channels and advertising channels, wherein corresponding information are received and processed by an advertising receiving device.

Although the present invention has been described herein before with reference to particular embodiments thereof, the present invention is not limited thereto and various modifications can be made thereto.

1.-9. (canceled)

10. An apparatus comprising
at least one processor,
at least one interface to at least one other network element, and at least one memory for storing instructions to be executed by the processor, wherein
the at least one memory and the instructions are configured to, with the at least one processor, cause the apparatus at least to perform:
a proximity services advertising agent function used in advertising services in a proximity services communication system for delivering advertising information via at least one advertising channel comprising one or more advertising control channels and one or more advertising traffic channels, and
a configuration information receiving and processing function configured to receive and process configuration information for configuring the at least one advertising channel, wherein
the configuration information comprises:
an identification element identifying the proximity services advertising agent function, and
advertising channel scheduling information allocated to the identified proximity services advertising agent and indicating resources used for transmitting the at least one advertising channel.

11. The apparatus according to claim 10, wherein
the configuration information receiving and processing function is configured to receive the configuration information partly or completely from a cellular communication network control element, and
the configuration information receiving and processing function is configured to receive the configuration information partly or completely in at least one of the following ways:
an indication of hardcoded information,
a provision of preconfiguration data provided during an access procedure of the apparatus to a cellular communication network, and
a broadcasting transmission of system information in the cellular communication network.

12. (canceled)

13. (canceled)

14. The apparatus according to claim 10, wherein the configuration information receiving and processing function is configured to receive and process an individual set of advertising channel scheduling information allocated to the proximity services advertising agent function, or a common set of advertising channel scheduling information allocated to plural proximity services advertising agent functions.

15. The apparatus according to claim 10, wherein the proximity services advertising agent function is further configured to transmit, on the basis of the configuration information, advertising channel scheduling information via at least one of a downlink control channel being synchronized with a downlink control channel transmitted from a cellular communication network control element and an advertising control channel.

16. The apparatus according to claim 15, wherein
the configuration information receiving and processing function is configured to derive, from the received configuration information, information about allocated downlink control channel resources for delivering information of a primary advertising control channel, scheduling information in frequency domain for the primary advertising control channel, and information about a semi-persistent resource allocation of secondary advertising control channels and secondary advertising traffic channels, and
the proximity services advertising agent function is further configured to transmit the scheduling information in frequency domain for the primary advertising control channel on the allocated downlink control channel resources.

17. The apparatus according to claim 15, wherein
the configuration information receiving and processing function is configured to derive, from the received configuration information, information about allocated downlink control channel resources for delivering information of a primary advertising control channel, scheduling information in frequency domain for the primary advertising control channel, information about a semi-persistent resource allocation of secondary advertising control channels and secondary advertising traffic channels, and information about allocated downlink control channel resources for delivering information about secondary advertising control channels and secondary advertising traffic channels, and
the proximity services advertising agent function is further configured to transmit the scheduling information for the primary and secondary advertising control channels on the respective allocated downlink control channel resources.

18. The apparatus according to claim 10, wherein the proximity services advertising agent function is further configured
to arrange advertising information of different advertising source devices to be transmitted in the advertising services in the proximity services communication system into plural categories,
to assign to each category respective advertising channels for delivering control and scheduling information, and
to provide mapping information indicating a mapping between each category and the assigned advertising channels.

19. The apparatus according to claim 10, wherein the proximity services advertising agent function is further configured
to arrange advertising information of different advertising source devices to be transmitted in the advertising services in the proximity services communication system into plural categories,
to assign to each category respective advertising channels for delivering control and scheduling information, and
to transmit scheduling information related to the assigned advertising channels in an advertising control channel, wherein the scheduling information are identified by a category related identifier.

20. The apparatus according to claim 18, wherein the proximity services advertising agent function is further configured
to provide a category based change notification for indicating a change in information transmitted via the advertising channels allocated to a respective category.

21. The apparatus according to claim 10, wherein the proximity services advertising agent function is further configured to use a predefined downlink control channel for providing information about the at least one advertising channel, or a predefined advertising channel, wherein the predefined downlink control channel or the predefined advertising channel is mapped on a physical identification element related to the proximity services advertising agent function.

22. (canceled)

23. An apparatus comprising
at least one processor,
at least one interface to at least one other network element, and
at least one memory for storing instructions to be executed by the processor, wherein
the at least one memory and the instructions are configured to, with the at least one processor, cause the apparatus at least to perform:
a proximity services advertising receiving function used in advertising services in a proximity services communication system for receiving advertising information delivered via at least one advertising channel comprising one or more advertising control channels and one or more advertising traffic channels, and
a configuration information receiving and processing function configured to receive and process configuration information for configuring the at least one advertising channel, wherein
the configuration information comprises:
an identification element identifying at least one proximity services advertising agent device of the advertising services in the proximity services communication system, and
advertising channel scheduling information indicating resources used for transmitting the at least one advertising channel by the identified at least one proximity services advertising agent device.

24. (canceled)

25. The apparatus according to claim 23, wherein the identification element comprises at least one of a physical identification or a logical identification of the at least one proximity services advertising agent device.

26. The apparatus according to claim 23, wherein the advertising channel scheduling information comprises at least one of
a radio network temporary identifier used for the at least one advertising channel,
scheduling information of the at least one advertising channel in time domain,
information about a modulation and coding scheme of the at least one advertising channel, and
scheduling information of the at least one advertising channel in frequency domain.

27. The apparatus according to claim 23, wherein the configuration information receiving and processing function is configured to receive and process an individual set of advertising channel scheduling information allocated to the proximity services advertising agent function, or a common set of advertising channel scheduling information allocated to plural proximity services advertising agent functions.

28. The apparatus according to claim 23, wherein the proximity services advertising receiving function is further configured to receive, on the basis of the configuration information, advertising channel scheduling information via at least one of a downlink control channel being synchronized with a downlink control channel transmitted from a cellular communication network control element and an advertising control channel transmitted from a proximity services advertising agent device.

29. The apparatus according to claim 28, wherein
the configuration information receiving and processing function is configured to derive, from the received configuration information, information about downlink control channel resources in which information regarding a primary advertising control channel is transmitted,
wherein the proximity services advertising receiving function is configured to receive scheduling information in frequency domain for the primary advertising control channel via the derived downlink control channel resources, and to receive further information regarding the advertising channels via the primary advertising control channel on the basis of the received scheduling information.

30. The apparatus according to claim 28, wherein
the configuration information receiving and processing function is configured to derive, from the received configuration information, information about downlink control channel resources in which information regarding primary and secondary advertising control channels is transmitted,
wherein the proximity services advertising receiving function is configured to receive scheduling information for the primary and secondary advertising control channels via the derived downlink control channel resources, and to receive further information regarding the advertising channels via the primary and secondary advertising control channel on the basis of the received scheduling information.

31. The apparatus according to claim 23, wherein the proximity services advertising receiving function is further configured
receive mapping information indicating a mapping between categories, in which advertising information of different advertising source devices to be transmitted in the advertising services in the proximity services communication system are arranged, and advertising channels respectively assigned to each category for delivering control and scheduling information, and
to receive and process information only from advertising channels assigned to a selected category.

32. The apparatus according to claim 31, wherein the proximity services advertising receiving function is further configured to select the advertising channels to be received and processed on the basis of an identifier linked to the category.

33. (canceled)

34. The apparatus according to claim 23, wherein the proximity services advertising receiving function is further configured to receive and process mapping information indicating a mapping of a physical identification element of a proximity services advertising agent device and a predefined downlink control channel providing information about the at least one advertising channel, or mapping information indicating a mapping of a physical identification element of a proximity services advertising agent device and a predefined advertising channel, and to receive information for advertising services via the predefined downlink control channel or the predefined advertising channel.

35. (canceled)

36.-72. (canceled)
